(19) United States
(12) Patent Application Publication
(10) Pub. No.: US 2024/0152786 A1
(43) Pub. Date: May 9, 2024

(54) SYSTEM AND METHOD FOR AGRICULTURAL DATA COMPARISON

(71) Applicant: Jared Ernest Kocer, Sioux Falls, SD (US)

(72) Inventor: Jared Ernest Kocer, Sioux Falls, SD (US)

(21) Appl. No.: 18/504,983

(22) Filed: Nov. 8, 2023

Related U.S. Application Data
(60) Provisional application No. 63/382,997, filed on Nov. 9, 2022.

(51) Int. Cl. G06N 5/04

(52) U.S. Cl. CPC G06N 5/04

(57) ABSTRACT

A method may include receiving an indication that a current instance of an agricultural operation has begun in a geographic area; receiving task characteristics of the agricultural operation; generating a first task data structure including the task characteristics, a field identifier associated with the geographic area, and a task identifier; storing the first task data structure in a database as associated with a first time period; accessing a second task data structure for the agricultural operation associated with a second time period, the second time period being before the first time period; inputting the first and second task data structures into a difference model; receiving an output from the difference model identifying a difference for a first characteristic of the task characteristics between first task data structure and second task data structure; generating a user interface with the identified difference; and presenting the user interface on a computing device.

### CROSS-RELATED APPLICATIONS

This patent application claims the benefit of U.S. Provisional Patent Application No. 63/382,997, titled “FIELD APPLICATION KNOWLEDGE” filed Nov. 9, 2022, which is herein incorporated by reference in its entirety.

### BACKGROUND

Various agricultural operations are performed on fields over the course of a calendar year. These operations may include tillage, fertilizing, planting, spraying, and harvesting. There are many variables associated with each operation that can impact the yield for the field. For example, for fertilizing, the fertilizer type, amount, application method, soil moisture, and weather conditions may all play a role.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is schematic illustration of field operations, according to various examples.

FIG. 3 illustrates inputs and outputs of a difference model, according to various examples

FIG. 4 is a flowchart illustrating a method to compare task characteristics according to various examples

FIG. 5 is a block diagram illustrating a machine in the example form of computer system, within which a set or sequence of instructions may be executed to cause the machine to perform any one of the methodologies discussed herein, according to various examples.

### DETAILED DESCRIPTION

In the following description, for purposes of explanation, numerous specific details are set forth to provide a thorough understanding of some example embodiments. It will be evident, however, to one skilled in the art that the present invention may be practiced without these specific details.

Throughout this disclosure, electronic actions may be performed by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless explicitly indicated as such, the use of “presenting a user interface” does not infer either one of these options.

Additionally, the elements and portions are sometimes described as being configured for a certain purpose. For example, an input element may be described as configured to receive an input string. In this context, “configured to” may mean presentation of a user interface element that can receive user input (e.g., text input from a keyboard). Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

There are many factors that influence the ultimate yield for a field (e.g., corn field, etc.) over a calendar year. For example, there are many operations that occur for each field such as tillage, fertilizing, planting, harvesting, etc. Each one of these operations has numerous variables—some that a farmer chooses and others that may be beyond the farmer's control—such as fertilizer type, fertilizer amount, planting depth, soil moisture, time of day, time of year, type of equipment used, etc.

It is often difficult to accurately analyze which one of these factors led to the yield or what (and by how much) variables change in each operation. This makes determining what changed from year-to-year that resulted in a different yield particularly challenging for a person to determine. Sometimes, an operator (e.g., a person operating a piece of agricultural equipment such as a combine harvester) may attempt to keep track of some of the details during each operation during a year. However, even simply repeating the same operations will lead to a different yield as many of the factors are not controllable by the farmer.

Furthermore, the information taken down by a farmer is generally incomplete and may be inaccurate. Additionally, an operator is not able to capture values for all the variables/factors that go into each operation. For example, an operator may not be able to determine the moisture level of soil acre-by-acre during an operation or temperature changes during the operation, etc. The introduction of variable rate application equipment also means the operator is not able to capture all the data that may go into an operation, let alone each operation during a calendar year. The result of the above deficiencies may lead to year-to-year variable yields with no (or incomplete) understanding of why.

Described herein are systems and methods to merge multiple disparate data sets with respect to field operations over a calendar year. The information may be a combination of user input, atmospheric conditions, and sensor readings from equipment, and operation details (e.g., task settings) related to the field operation. The systems and methods are not merely improved record keeping but provide advantages to the agricultural operations and agricultural equipment. For example, after the system has collected data for a full calendar year, suggestions and recommendations may be presented to the operator during a subsequent year. Thus, the system may use real time monitoring to determine that there is a difference in a variable from one year to another and transmit a message to the operator. The message may indicate the difference and request information as to why the change was made or suggest changing to a different setting. Over multiple years, the system may learn what variables have the greatest impact on yield from year to year.

Furthermore, a user interface tool may be used to explore the differences from year-to-year and from field-to-field. In various examples, an operator may compare their yield to other similar fields. The fields may be anonymized such that it is not possible to determine the actual location of a field but may still be used for comparisons.

Additionally, the system may be at least partially automated such that the information is stored in field data structures in real time when a task for a field is commenced, or when a piece of agricultural equipment reads a field identifier. Further benefits may be apparent to one of skilled in the art upon reading this disclosure.

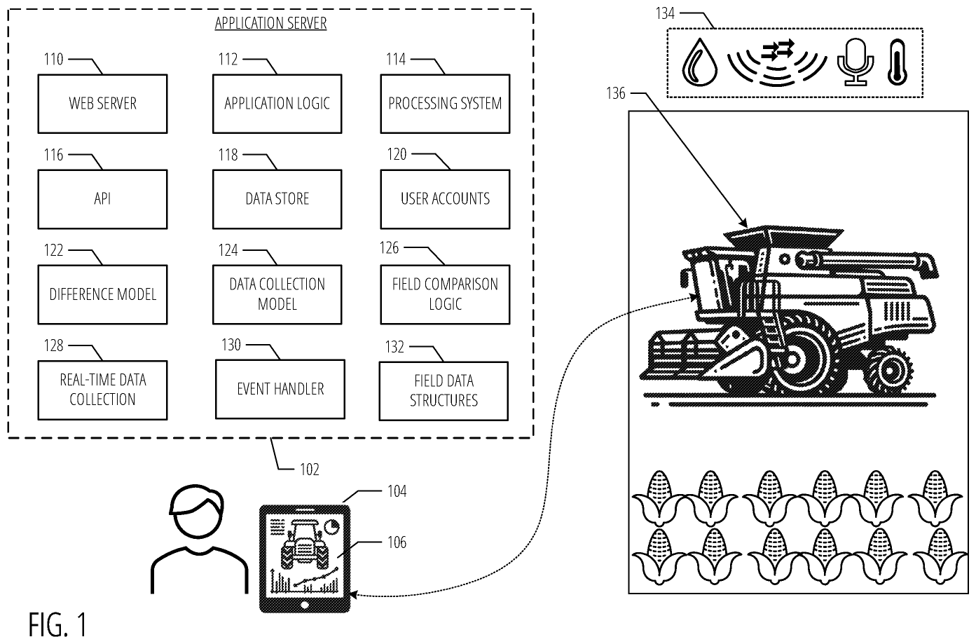

FIG. 1 is an illustration of components of a client device and an application server, according to various examples. The illustration includes an application server 102, a client device 104, a web client 106, a web server 110, an application logic 112, a processing system 114, an API 116, a data store 118, a user accounts 120, a difference model 122, a data collection model 124, a field comparison logic 126, a real-time data collection 128, an event handler 130, a field data structures 132, a sensors 134, and an agricultural equipment 136.

Application server 102 is illustrated as set of separate elements (e.g., component, logic, etc.). However, the functionality of multiple, individual elements may be performed by a single element. An element may represent computer program code that is executable by processing system 114. The program code may be stored on a storage device (e.g., data store 118) and loaded into a memory of the processing system 114 for execution. Portions of the program code may be executed in a parallel across multiple processing units (e.g., one or more cores of a general-purpose computer processor, a graphical processing unit, an application specific integrated circuit, etc., operating alone or in combination to execute the instructions) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Client device 104 may be a computing device which may be, but is not limited to, a smartphone, tablet, laptop, multi-processor system, microprocessor-based or programmable consumer electronics, game console, set-top box, or another device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Furthermore, although only a single client device 104 is illustrated in FIG. 1, application server 102 may communicate with multiple client devices. For example, one client device may be installed as a computer in agricultural equipment 136. Another client device may be used by a user at their business or home to connect with application server 102 and view output from difference model 122.

Agricultural equipment 136 may be, but is it not limited to a combine harvester, cultivator, tractor, sprayer, or truck carrying supplies to and from a field, etc. The agricultural equipment 136 may have one or more sensors such as sensors 134. The sensor types may include, but are not limited to, temperature, humidity, soil moisture, optical cameras, infrared cameras, wind speed, Global Positioning System (GPS), and microphone.

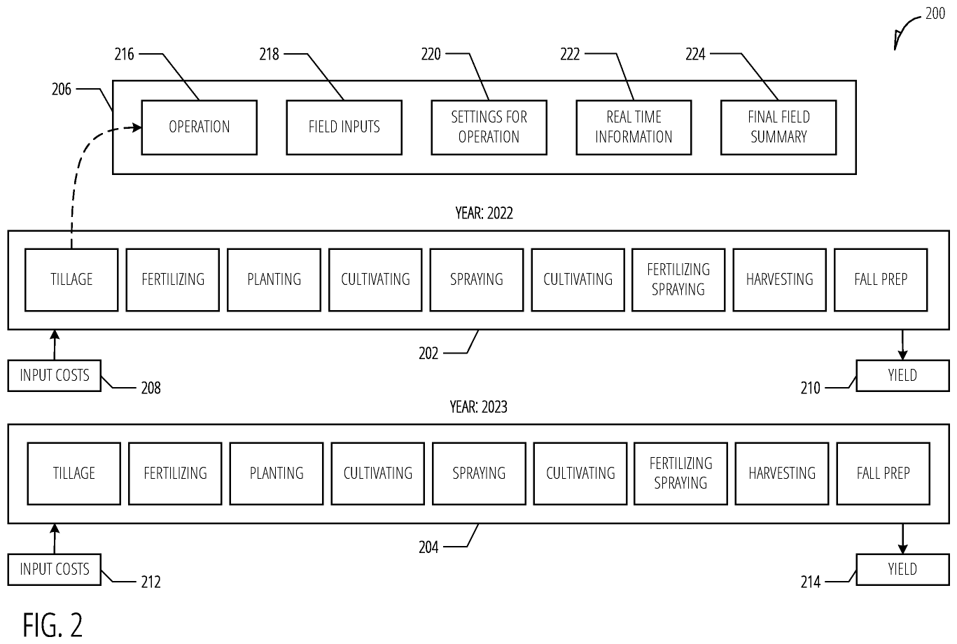

Agricultural equipment 136 may have one or more computing devices (e.g., client device 104) that include logic related to performing agricultural tasks (also referred to as operations herein). For example, an agricultural task may be to perform fertilization on a field. As the task is being performed, a computing device of agricultural equipment 136 may collect and store a log of variable values related to the agricultural equipment 136 such as speed, application rate of a product to a field, etc.—as well as sensor readings from sensors 134. The variable values may be stored as associated with the GPS location of the agricultural equipment 136 during the task. Accordingly, it may be possible to cross-reference average variable values for a particular area (e.g., acre) of the field to another location or between years. Further elaboration on data collection with respect to operations is discussed in the context of FIG. 2.

External sources, not shown, may also communicate data to application server 102 that may be cross-referenced tasks performed on a field. For example, application server 102 may transmit requests for data from weather services that include reports on severe weather (e.g., hail damage, tornados, etc.), first frost dates, wind speeds, etc.

Client device 104, application server 102, sensors 134, and the external sources may communicate via a network (not shown). In various examples, sensor readings may be relayed through client device 104 or another communication device on agricultural equipment 136. The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

In some examples, the communication may occur using an application programming interface (API) such as API 116. An API provides a method for computing processes to exchange data. A web-based API (e.g., API 116) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a Database (e.g., data store 118). For example, application server 102 may include an API to receive task variables related to an operation performed by agricultural equipment 136. The data may be stored in a task data structure. The task data structure may include a task identifier, a field identifier, and variable values received over the API, in various examples.

Application server 102 may include web server 110 to enable data exchanges with client device 104, agricultural equipment 136, and sensors 134 via web client 106. Although generally discussed in the context of delivering data via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

Additionally, web server 110 may enable a user to interact with one or more web applications provided in a transmitted web page. A web application may provide user interface (UI) components that are rendered on a display device of client device 104. The user may interact (e.g., select, move, enter text into) with the UI components, and based on the interaction, the web application may update one or more portions of the web page. A web application may be executed in whole, or in part, locally on client device 104. The web application may populate the UI components with data from external sources or internal sources (e.g., data store 118) in various examples.

In various examples, more than one web application may be served by web server 110. For example, a task web application may be used by client device 104 when an operator is using agricultural equipment 136. The task web application may be used to transmit and receive information from an operator during an agricultural task. For example, as discussed in more detail with respect to FIG. 2, the task web application may request information from the operator related to conditions of the field that may not be readily detectable by sensors of agricultural equipment 136. The task web application may also transmit suggested changes to an operation if the operator appears to be using settings that may result in a lower yield (e.g., based on the output from difference model 122).

Another web application may present difference visualizations. The difference visualization web application may be used to review details on operations performed on a field and differences between years. Difference visualization web application may also be used to compare two yields fields that have similar characteristics (e.g., same type of crop, temperature, geographic region, etc.). A similarity calculation may be used to determine similar fields. For example, a weighted sum of multiple characteristics (e.g., 0.2[size of field]+0.3[soil composition]+ . . . ) may result in zero to one value, with one being the most similar. Application server 102 may obfuscate (e.g., show a square field instead of the actual shape of the field) the actual geometry and location of the comparison field to protect the privacy of another field owner as a user preference. Each field owner may also prevent their fields from being used in comparisons by other owners.

The web application(s) may be executed according to application logic 112. Application logic 112 may use the various elements of application server 102 to implement the web application. For example, application logic 112 may issue API calls to retrieve or store data from data store 118 and transmit it for display on client device 104. Similarly, data entered by a user into a UI component may be transmitted using API 116 back to the web server. Application logic 112 may use other elements (e.g., difference model 122, data collection model 124, field comparison logic 126, etc.) of application server 102 to perform functionality associated with the web application as described further herein.

Data store 118 may store data that is used by application server 102. Data store 118 is depicted as singular element but may be multiple data stores. The specific storage layout and model used in by data store 118 may take several forms—indeed, a data store 118 may utilize multiple models. Data store 118 may be, but is not limited to, a relational database (e.g., SQL), non-relational database (NoSQL) a flat file database, object model, document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and may be in one or more geographic areas.

Data store 118 may store several types of data structures such as field data structures 132 and task data structures. A field data structure may include an identifier (e.g., an alphanumeric sequence) of the field, the metes and bounds of the field (e.g., based on an area defined by GPS coordinates), and be associated with (e.g., linked to in a database table) one or more task data structures. Data collection may be limited to the geographic area defined by the field data structure. A task data structure may store information on an operation performed on a field and include settings for the operation, results of the operation, and data collected during the operation, etc.

Data structures may be implemented in several manners depending on a programming language of an application or database management system used by an application. For example, if C++ is used, the data structure may be implemented as a struct or class. In the context of a relational database, a data structure may be defined in a schema with one or primary and secondary keys linking tables of the database. In various examples, the schemas may be stored in data collection model 124.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples.

User accounts 120 may store accounts for multiple types of users. For example, there may be equipment operators, field owners, etc. A user is not limited to having only one type. Depending on the type (or selected type), however, different information may be presented to the user. For example, while operating agricultural equipment, a user may be presented a web application that includes information on the current task and include options to respond to questions as the task is being completed. A user account may be associated (e.g., linked in a database) with one or more field data structures. When in a field owner mode, information on completed tasks and yearly summary information may be presented for their associated fields, as discussed in more detail below.

Event handler 130 may manage incoming and outgoing requests for data from application server 102. For example, although not depicted, application server 102 may include a task management system for assigning tasks to the fields. Event handler 130 may receive an indication an assigned task has begun from a piece of agricultural equipment. For example, agricultural equipment 136 may include a camera sensor that captures a field identifier (e.g., a QR code or alphanumeric sequence) on a post in the field and transmit the identifier to application server 102 as defined in a field data structure. In another example, application server 102 may monitor the location of agricultural equipment 136 and infer a job has started once agricultural equipment 136 enters a field.

During the task, event handler 130 may request data from agricultural equipment 136 or the user via client device 104. For example, if difference model 122 indicates that the operator is deviating from prior settings of the same task beyond a certain threshold amount, a request may be sent to the operator requesting information on why the change was made. Similarly, event handler 130 may transmit a message to the operator identifying suggestions of how to better optimize the yield based on the current operation.

Event handler 130 may also request data from external sources before, during, or after a task is being performed on a field. For example, weather conditions may be requested from a weather service, or sensor readings from the field that may not be immediately available from agricultural equipment 136. The received information may be added to a task data structure of the current task. Additionally, event handler 130 may transmit a message to real time data collection 128 to collect data from agricultural equipment 136 during the operation. This information may include current settings of the equipment and conditions monitored by sensors of the equipment.

FIG. 2 is a schematic illustration 200 of field operations, according to various examples. The diagram illustrates a yearly operations 202, a yearly operations 204, an operation workflow 206, an input costs 208, a yield 210, an input costs 212, a yield 214, an operation 216, a field inputs 218, a settings for operation 220, a real time information 222, and a final field summary 224.

Yearly operations 202 may represent the operations performed on a field for a first calendar year (e.g., 2022) and yearly operations 204 may represent the operations performed on the field in a subsequent year (e.g., 2023). Each set of yearly operations may have its own inputs costs (e.g., input costs 208 and input costs 212) and resulting yields (e.g., yield 210 and yield 214). Input costs may be the amount spent on seed, fertilizer, etc., and yield may be the amount of crop realized after harvesting. The order and types of operations are for illustration purposes, and different fields may have a different set of operations that are performed. An operation in yearly operations 202 (and yearly operations 204) may be stored as a task data structure in data store 118, in various examples.

An operation may be associated with several data points that are stored in a task data structure—such as depicted in operation workflow 206. For example, the type of operation may be stored as operation 216 and field inputs 218 may include an identifier of the field. Settings for operation 220 may include the machine type/implement used for the operation, an application rate and type of a product (if applicable), the depth of the operation, speed, and size of rows, among others.

Real time information 222 may include information collected by the agricultural equipment and sensors during the operation (e.g., using real-time data collection 128). This information may include a tilling depth, an application rate, harvest information, soil composition (e.g., chemical makeup), soil temperature at different depths, air temperature, date, and elevation. This information may be gathered multiple times over the course of an operation such as acre by acre, every 10 feet, etc., accordingly to a user preference.

As indicated previously, real time information 222 may also be used to request information from an operator such as ground conditions (e.g., the presence of certain insects in the field, which way crops were leaning, were there kernels on the group, or the degree of difficulty in harvesting) that may not be readily detectable by onboard systems. Furthermore, not all agricultural equipment is designed with network enabled sensors. For example, the tilling depth may be set by an operator and not via an electronic command that can be relayed to application server 102. Accordingly, real time information 222 may request information from the operator based on the type of equipment (e.g., if a sensor is not present, real time information 222 may request the information) being used such as what product is being placed into a field, tilling depth etc.

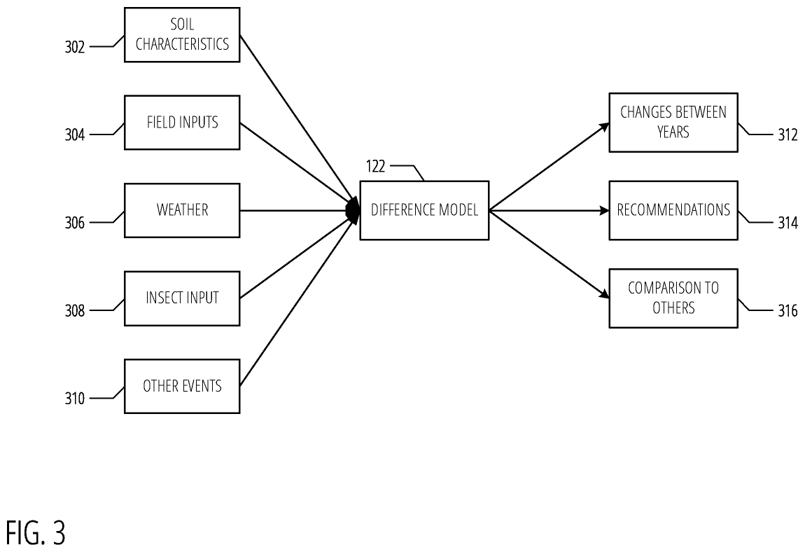

Final field summary 224 may be the agglomeration of field inputs 218, settings for operation 220, and real time information 222 in a field data structure. There may also be a year-end field summary (e.g., a webpage or other user interface) that includes links (e.g., selectable user interface elements) to the individual field summaries for each operation. Accordingly, a user may be able to log in to application server 102 to view fields associated with their account and drill down to each operation performed and event sub-sections of the field (e.g., a particular acre). For example, application server 102 may present a map of the field segmented (e.g., using bold lines) according to the sub-section. Difference model 122 may output the differences between yields in each sub-section as well, as discussed in more detail below with respect to FIG. 3.

FIG. 3 illustrates inputs and outputs of a difference model, according to various examples. FIG. 3 includes a difference model 122, a soil characteristics 302, a field inputs 304, a weather 306, an insect input 308, an other events 310, a changes between years 312, a recommendations 314, and a comparison to others model 316.

Difference model 122 may be more than one model in various examples. For example, a logistic regression model may be trained over a period of years and fields to determine what factors and components of each factor have the most impact on yield. Factors may include (e.g., soil characteristics 302. field inputs 304, weather 306, insect input 308, other events 310, yield, etc. Accordingly, when a user logs into application server 102 they may be presented with their yield for a year and the percentage impact each of the collected factors.

Another model (e.g., changes between years 312) may calculate the absolute difference between years for each factor and display the results in a table. For example, for a two-year comparison there may be one column for the first year, a second column for a second year, and a third column with the difference. The third column may be blank for factors that are not quantitative (e.g., a product type or agricultural equipment type). The table may be dynamically updated based on selections of different fields (e.g., as displayed in a list on a user interface) and sub-part selections of the field (e.g., a particular acre(s)).

A recommendation model (e.g., recommendations 314) may output suggested changes in a following year's operations or in real-time as the operations occur. For examples, event handler 130 may detect that an operation has begun in a field and that one or more input settings for the operation is different by a threshold amount than a prior year. The logistic regression model may further indicate that the setting type (e.g., tilling depth) has a coefficient above some set preference (e.g., 15%) with respect to the yield. Based on the event and logistic regression model, a message may be transmitted to the operator suggesting the setting be set back to where it was the prior year.

The recommendation model may also leverage information learned from other similar fields. For example, the recommendation model may learn (e.g., using another logistic model or trained neural network) that planting below a certain temperature results in a lower yield. Accordingly, during an operation, if real-time data collection 128 receives information that the temperature is below the threshold, a message may be transmitted to the operator to consider performing the operation a different time.

Difference model 122 may also be used to compare fields across owners. In various examples, the comparison to others model 316 may not be enabled until a certain threshold of fields have yearly data for their operations. By not enabling the comparison to others model 316 immediately, privacy may be ensured should only a few fields be in the system in the beginning.

Comparison to others model 316 may use ranges instead of absolute values when making comparisons as well. For example, the user's field may include the actual field summary information whereas a comparison field may round certain values. In other examples, the comparison field may include the actual values as well. Comparison to others model 316 may also selection of a plurality of fields and use averages across the plurality for comparison. The comparison may be at any level of the field data structure and task data structure level. For example, a user may use comparison to others model 316 to compare a fertilizer operation for the past year.

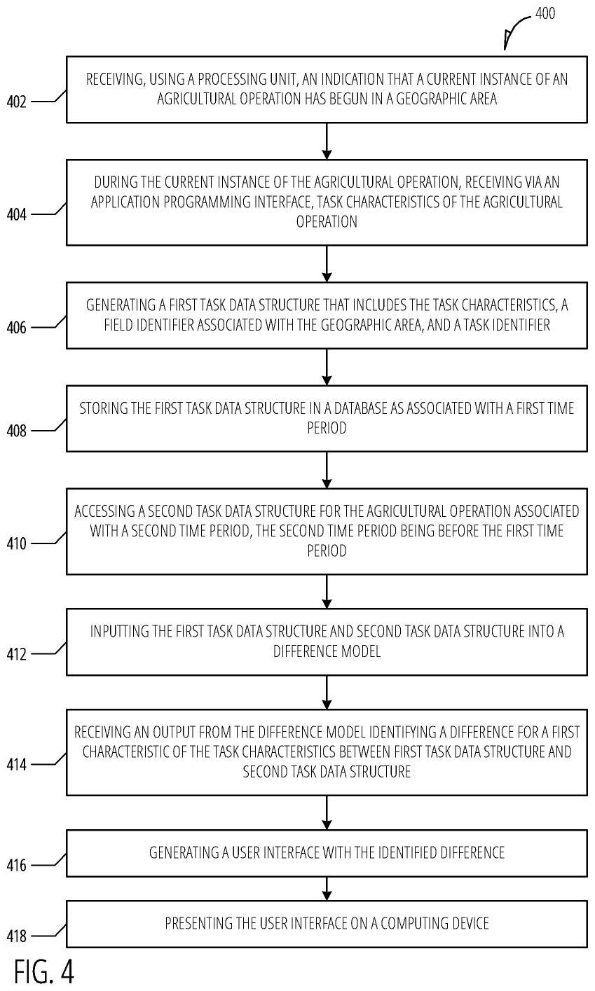

FIG. 4 is a flowchart illustrating a method to compare task characteristics according to various examples. The method is represented as a set of blocks that describe operations of method 400. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 4. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In operation 402, method 400 receives, using a processing unit, an indication that a current instance of an agricultural operation has begun in a geographic area. For example, consider that an agricultural operation has begun a field and a camera on a piece of agricultural equipment has captured a QR code on a fence post as it entered the field. The QR code may include an identifier of the field. Accordingly, a computing device onboard or proximate to the agricultural equipment may transmit a message via an API to application server 102 that includes the field identifier and other task characteristics.

In various examples, method 400 includes operation 404, which during the current instance of the agricultural operation, receives via an application programming interface, task characteristics of the agricultural operation. The task characteristics may be ones such as discussed above in operation workflow 206. For example, the task characteristics may be environmental sensor readings such as soil temperature or user inputted data such as the level of debris in the field. The task characteristics may include real-time data collected from a piece of agricultural equipment performing the agricultural operation. The real-time data may include a time then data was collected and GPS coordinates of the location of the data for later sub-section field comparisons.

In operation 406, method 400 generates a first task data structure that includes the task characteristics, a field identifier associated with the geographic area, and a task identifier. In operation 408, method 400 stores the first task data structure in a database as associated with a first time period. For example, the database may be part of data store 118. The task identifier may indicate the type of operation being performed. The method may also include generating a field data structure data structure, the field data structure data structure including the first task data structure and second task data structure and storing the field data structure in the database.

In operation 410, method 400 accesses a second task data structure for the agricultural operation associated with a second time period, the second time period being before the first time period. Accessing may include querying the database using the field identifier and an operation type of the same type as the agricultural operation being performed in operation 402. For example, the same type of operation (e.g., fertilizing) may have been performed on the same field in a prior year.

In operation 412, method 400 inputs the first task data structure and second task data structure into a difference model. The difference model may be one such as discussed in FIG. 1 and FIG. 3 (e.g., difference model 122). Inputting may include reformatting data according to the type of difference model. For example, if difference model 122 is a neural network, data in the first task data structure and second task data structure may be reformatted into vector values. In other examples, inputting may include remove data from the first task data structure and second task data structure that are not used by the difference model (e.g., the difference model may not use soil characteristics).

In operation 414, method 400 receives an output from the difference model identifying a difference for a first characteristic of the task characteristics between first task data structure and second task data structure. For example, there may be a difference in yield and soil temperature. In various examples, the difference model does not output each difference between the first task data structure and second task data structure. The difference model may instead use a threshold change (e.g., percentage change or absolute) before determining a difference is significant enough to display.

In operation 416, method 400 generates a user interface with the identified difference and in operation 418, method 400 presents the user interface on a computing device. For example, the user interface may include columns for the task characteristics and rows for the values for the respective task characteristics in the first task data structure and second task data structure and a row indicating the differences between the two.

The method may also include where the user interface includes a field selection portion configured to receive a selection of a field from a plurality of fields, a sub-selection portion configured to receive a selection of a sub-section of a field, and a difference portion displaying the identified difference.

The method may also include receiving an identifier of a selected field from the field selection portion, receiving an identifier of a selected sub-section of the selected filed from the sub-selection portion, receiving an output from the difference model identifying a difference in a yield value for the selected sub-section in the first task data structure and second task data structure, and presenting the difference in the yield value in the user interface. For example, a query may be initiated to data store 118 using the field identifier of the selected field a sub-portion identifier of the selected sub-portion to retrieve the yield values.

The method may also include receiving a value of a task characteristic of the task characteristics of the agricultural operation, inputting the value of the task characteristic of the current instance into the difference model, receiving an output from the difference model identifying a recommendation for the agricultural operation. For example, as the agricultural operation is being performed a soil temperature reading may be collected and transmitted to application server 102 via an API. The difference model (e.g., a regression model) may indicate that a soil temperature, below a certain value, results in a statistically significant decrease in yield. Accordingly, if the received soil temperature reading is below that threshold, a postponement recommendation may be transmitted to a computing device of an operator of the agricultural equipment.

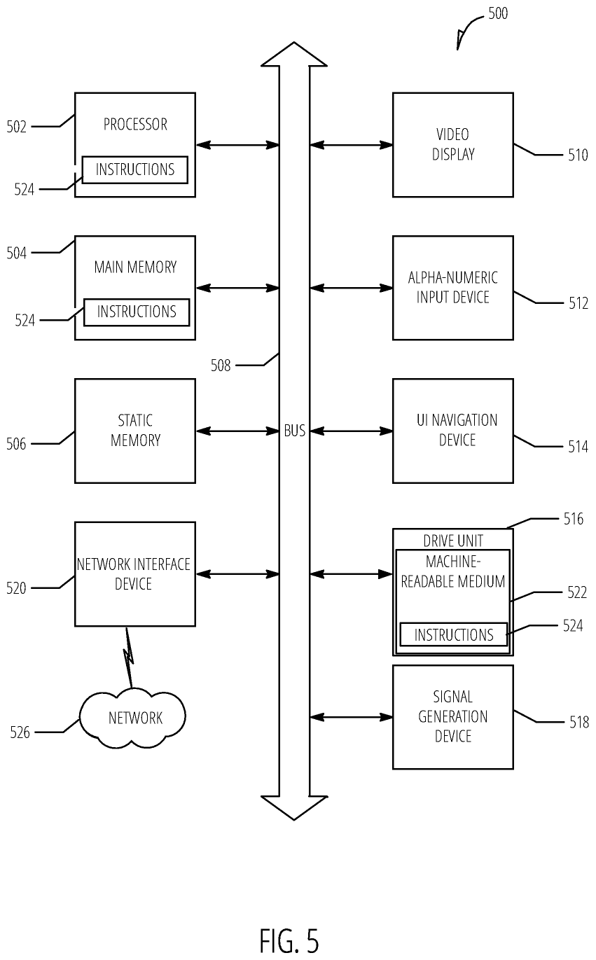

FIG. 5 is a block diagram illustrating a machine in the example form of computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508. The computer system 500 may further include a video display unit 510, an input device 512 (e.g., a keyboard), and a user interface (UI) navigation device 514 (e.g., a mouse). In one embodiment, the video display unit 510, input device 512, and UI navigation device 514 are incorporated into a single device housing such as a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed Database, and/or associated caches and servers) that store the one or more instructions 524. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excluded transitory signals.

The instructions 524 may further be transmitted or received over a communications network 526 using a transmission medium via the network interface device 520 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A system comprising:
a processing unit;
a storage device comprising instructions, which when executed by the processing unit, configure the processing unit to perform operations comprising:
receiving, using a processing unit, an indication that a current instance of an agricultural operation has begun in a geographic area;
during the current instance of the agricultural operation, receiving via an application programming interface, task characteristics of the agricultural operation;
generating a first task data structure that includes the task characteristics, a field identifier associated with the geographic area, and a task identifier;
storing the first task data structure in a database as associated with a first time period;
accessing a second task data structure for the agricultural operation associated with a second time period, the second time period being before the first time period;
inputting the first task data structure and second task data structure into a difference model;
receiving an output from the difference model identifying a difference for a first characteristic of the task characteristics between first task data structure and second task data structure;
generating a user interface with the identified difference; and
presenting the user interface on a computing device.

2. The system of claim 1, wherein the instructions, which when executed by the processing unit, further configure the processing unit to perform operations comprising:
receiving a value of a task characteristic of the task characteristics of the agricultural operation;
inputting the value of the task characteristic of the current instance into the difference model;
receiving an output from the difference model identifying a recommendation for the agricultural operation.

3. The system of claim 2, wherein the task characteristic is soil temperature, and the recommendation is a postponement recommendation based on the soil temperature being below a threshold value.

4. The system of claim 1, wherein the task characteristics include real-time data collected from a piece of agricultural equipment performing the agricultural operation.

5. The system of claim 1, wherein the task characteristics include user input data associated with the agricultural operation.

6. The system of claim 1, wherein the task characteristics include an environmental sensor reading of the geographic area.

7. The system of claim 1, wherein the instructions, which when executed by the processing unit, further configure the processing unit to perform operations comprising:
generating a field data structure data structure, the field data structure data structure including the first task data structure and second task data structure; and
storing the field data structure in the database.

8. The system of claim 1, wherein the user interface includes:
a field selection portion configured to receive a selection of a field from a plurality of fields;
a sub-selection portion configured to receive a selection of a sub-section of a field; and
a difference portion displaying the identified difference.

9. The system of claim 8, wherein the instructions, which when executed by the processing unit, further configure the processing unit to perform operations comprising:
receiving an identifier of a selected field from the field selection portion;
receiving an identifier of a selected sub-section of the selected filed from the sub-selection portion;
receiving an output from the difference model identifying a difference in a yield value for the selected sub-section in the first task data structure and second task data structure; and
presenting the difference in the yield value in the user interface.

10. A method comprising:
receiving, using a processing unit, an indication that a current instance of an agricultural operation has begun in a geographic area;
during the current instance of the agricultural operation, receiving via an application programming interface, task characteristics of the agricultural operation;
generating a first task data structure that includes the task characteristics, a field identifier associated with the geographic area, and a task identifier;
storing the first task data structure in a database as associated with a first time period;
accessing a second task data structure for the agricultural operation associated with a second time period, the second time period being before the first time period;
inputting the first task data structure and second task data structure into a difference model;
receiving an output from the difference model identifying a difference for a first characteristic of the task characteristics between first task data structure and second task data structure;
generating a user interface with the identified difference; and
presenting the user interface on a computing device.

11. The method of claim 10, further comprising:
receiving a value of a task characteristic of the task characteristics of the agricultural operation;
inputting the value of the task characteristic of the current instance into the difference model; and
receiving an output from the difference model identifying a recommendation for the agricultural operation.

12. The method of claim 11, wherein the task characteristic is soil temperature, and the recommendation is a postponement recommendation based on the soil temperature being below a threshold value.

13. The method of claim 10, wherein the task characteristics include real-time data collected from a piece of agricultural equipment performing the agricultural operation.

14. The method of claim 10, wherein the task characteristics include user input data associated with the agricultural operation.

15. The method of claim 10, wherein the task characteristics include an environmental sensor reading of the geographic area.

16. The method of claim 10, further including:
generating a field data structure data structure, the field data structure data structure including the first task data structure and second task data structure; and
storing the field data structure in the database.

17. The method of claim 10, wherein the user interface includes:
a field selection portion configured to receive a selection of a field from a plurality of fields;
a sub-selection portion configured to receive a selection of a sub-section of a field; and
a difference portion displaying the identified difference.

18. The method of claim 17, further comprising:
receiving an identifier of a selected field from the field selection portion;
receiving an identifier of a selected sub-section of the selected filed from the sub-selection portion;
receiving an output from the difference model identifying a difference in a yield value for the selected sub-section in the first task data structure and second task data structure; and
presenting the difference in the yield value in the user interface.

19. A non-transitory computer-readable medium comprising instructions, which when executed by a processing unit, configure the processing unit to perform operations comprising:
receiving, using a processing unit, an indication that a current instance of an agricultural operation has begun in a geographic area;
during the current instance of the agricultural operation, receiving via an application programming interface, task characteristics of the agricultural operation;
generating a first task data structure that includes the task characteristics, a field identifier associated with the geographic area, and a task identifier;
storing the first task data structure in a database as associated with a first time period;
accessing a second task data structure for the agricultural operation associated with a second time period, the second time period being before the first time period;
inputting the first task data structure and second task data structure into a difference model;
receiving an output from the difference model identifying a difference for a first characteristic of the task characteristics between first task data structure and second task data structure;
generating a user interface with the identified difference; and
presenting the user interface on a computing device.

20. The non-transitory computer-readable medium of claim 19, wherein the instructions, which when executed by the processing unit, further configure the processing unit to perform operations comprising:
receiving a value of a task characteristic of the task characteristics of the agricultural operation;
inputting the value of the task characteristic of the current instance into the difference model; and
receiving an output from the difference model identifying a recommendation for the agricultural operation.
